(19) United States
(12) Patent Application Publication
(10) Pub. No.: US 2019/0243867 A1
(43) Pub. Date: Aug. 8, 2019

(54) EMERGENT TIME TO CAUSAL TIME SIGNAL TRANSFORMATIONS

(71) Applicant: Bradley Nelson Eckert, Chandler, AZ (US)

(72) Inventor: Bradley Nelson Eckert, Chandler, AZ (US)

(21) Appl. No.: 15/888,082

(22) Filed: Feb. 5, 2018

(51) Int. Cl. G06F 17/14; H04B 1/69

(52) U.S. Cl. CPC G06F 17/142; H04B 1/69; G06F 17/30539; H04B 2001/6916; H04B 2001/6912

(57) ABSTRACT

A demodulator for receiving signals modulated in emergent time, comprised of an exponential time warping input stage, an FFT to convert to the frequency domain, and an exponential time warping output stage to map the recovered modulation onto the causal time domain. Overlapped blocks are correlated by summing the warped outputs, providing selectivity and gain. Tuning is by means of matching the warp rate of emergent time. A modulator performs the reverse function.

### TECHNICAL FIELD

The invention relates to the signal analysis of nonlinear dynamics.

### BACKGROUND

Flicker noise (or 1/f noise), has a power spectrum proportional to 1/f^{α} (0.7<α<1.4). It's a type of noise prevalent in many natural systems. Flicker noise is seen in music, seismic data, EEG and ECG data, and electronic devices. Two of the most popular explanations for the 1/f spectrum are:

1. A superposition of relaxation processes.

2. Carrier mobility fluctuations through Coulomb scattering.

There are a good number of hypotheses for 1/f noise, to which we add one more:

3. The superposition of exponential chirps.

A single exponential chirp has a power spectrum, with scale σ and “warp factor” ω, of:

Power=σ·|ω|·e^{-|ω|f} [Math. 1]

A distribution of chirps of various ω values exponentially spaced, where log(|ω|) is uniformly spaced, combines to form a 1/f spectrum. So, there is a plausible basis for 1/f noise being composed of exponential chirps. The 1/f noise in electronic devices and sensors also has material causes, which should be treated as actual noise. The 1/f noise from exponential chirps could be treated as signal rather than ignored.

There are two distinct types of time: emergent time, which emanates from the structure of spacetime and its metrics, and a causal time, indicating the flow from the past to the future. For it to be scale invariant, we use an exponential growth model for emergent time: τ=αe^{βt}. Resonance is considered a physical phenomenon and time T emergent. A resonant frequency in emergent time is equivalent to an exponential chirp in causal time. This dynamic emergence of time should produce small but detectable artifacts before it merges with the spacetime of the apparent universe.

Biological systems evolve to minimize the expenditure of energy. Resonances (field analogs of electrical and mechanical ringing) require a small energy input to keep them going, assuming a reasonably high Q. It stands to reason that biological systems would use field resonances in the physical vacuum (the exact nature of the field needs not be understood) to transmit consciousness information efficiently.

The 1/f spectrum suggests that a multiplicity of emergent time rates exist. The idea of consciousness as time quanta may be useful here. Nature evolves to fill the spectrum of emergent time, to utilize available bandwidth. One could call this spectrum “the sound of the Tao”.

Since exponential chirps are bounded in time, information must be a stream of chirps. Individual chirps correspond to discrete impulses in the causal time domain. The impulse stream may be decoded for its information content. Overlapping chirps can be resampled and self-correlated to construct a causal time domain signal for one or a multiplicity of w values. A sweep of w can be used to construct a “warp spectrum” (for example, on a computer display), useful for finding emergent-time signals.

### SUMMARY OF INVENTION

### Technical Problem

Biological signals are assumed, in the industry, to be best analyzed in causal time or through fractal scales in causal time. The nonlinear mechanics of emergent time are not utilized. As emergent space-time geometry is linked to observation, classic 1/f “noise” in some electronics as well in biological telemetry data will contain important artifacts of consciousness that are being ignored.

### Solution to Problem

To establish a notation and unit of measurement for the exponent of the chirp frequency, let the “warp factor” ω be in units of e, the mathematical constant derived by Leonhard Euler in the 1720s, per unit time. The pronunciation may be “e's per second” for e/s, for example. We propose “len” for the unit name of e/s, after Leonhard. Some scale factors to other units: 0.69 lens is one octave per second, 2.3 lens is one order per second, and 0.48 lens is one golden mean (4)=1.618:1) per second. Note that a len is very close to twice the Golden Ratio, so one must be careful when making assumptions about Golden Ratio relationships in nature.

Exponential chirp signals in the emergent time domain are re-mapped to the causal time domain and demodulated by correlating a time series of exponential chirp transforms, producing a causal time domain version of the demodulated signal. This then allows analysis and data mining using more traditional data processing technologies such as speech analysis and pattern recognition.

The process may be done in reverse: Causal time domain signals are re-mapped to the emergent time domain by correlating a time series of fast inverse exponential chirp transforms. This may be used, for example, to generate therapeutic signals and test signals.

### Advantageous Effects of Invention

The invention is advantageous in the field of data mining. Modern electronics can support new classes of applications, using consciousness as the medium. The low-hanging fruit is a new class of vital statistics that gauges states of consciousness, pain levels, and bodily health. The invention ignores periodic signals, seeing them as wideband noise. This is a great advantage, since spurious signals such as birdies and other undesired interference fall below the “noise floor”.

### BRIEF DESCRIPTION OF DRAWINGS

FIG. 1A shows an embodiment of an apparatus for emergent to causal time demodulation.

FIG. 1B shows the data flow of emergent to causal time demodulation.

FIG. 2A shows an embodiment of an apparatus for causal to emergent time modulation.

FIG. 2B shows the data flow of causal to emergent time modulation.

FIG. 3A shows sample spacing in time at various points in the demodulation process.

FIG. 3B illustrates the conversion process moving along the I/O streams.

FIG. 4A shows the input stream in time.

FIG. 4B shows downsampling interpolation before the FFT.

FIG. 4C shows upsampling interpolation after the FFT.

FIG. 4D shows the output correlation in time.

FIG. 5A illustrates power spectra.

FIG. 5B illustrates the relationship between emergent time and causal time.

### DESCRIPTION OF EMBODIMENTS

### Example 1

The invention is analogous to an AM/FM receiver. Selectivity and processing gain are determined by the oversampling rate (how many times the FFT includes the same ADC sample). High oversampling sees many copies of the scale-invariant chirp, offset in time, and correlates them by summation.

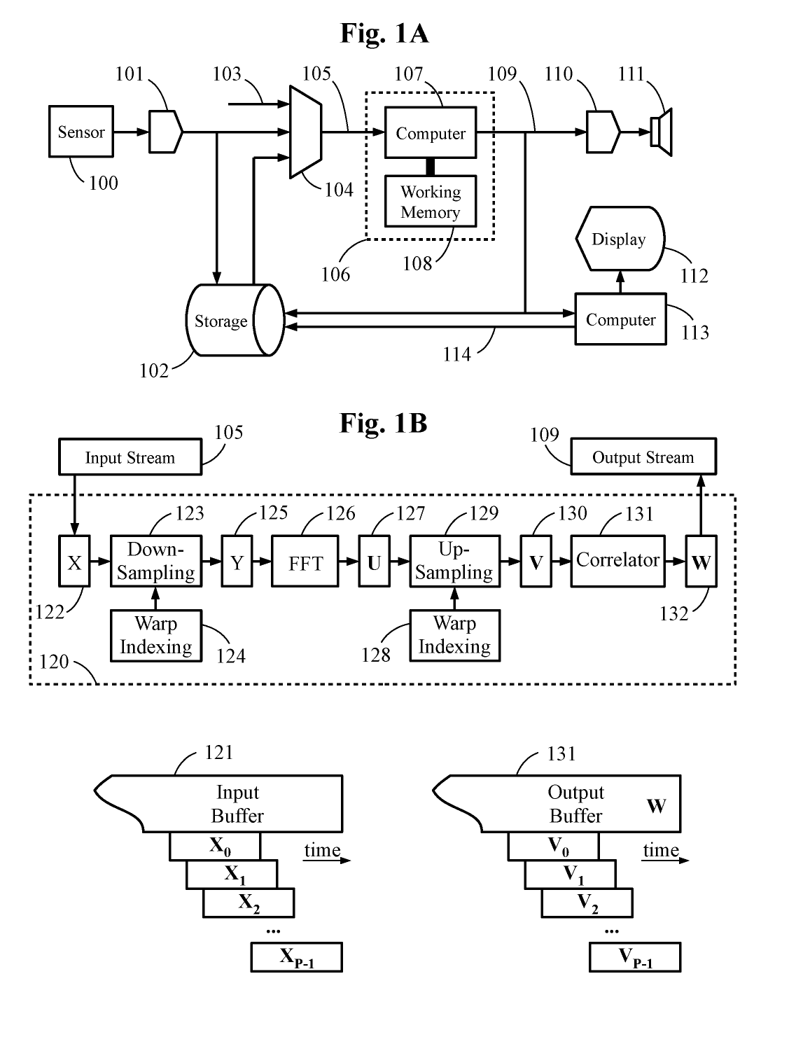

FIG. 1A shows an embodiment of an apparatus for emergent to causal time conversion. Sensor 100 is a device or process that has analog 1/f noise in its output. Most sensors that monitor natural biophysical processes, such as EEG (electroencephalogram), ECG (electrocardiogram) and heartbeat exhibit 1/f noise. Most electronic devices exhibit various amounts of 1/f noise. These include reverse biased Schottky diodes, forward biased PN junctions, MOSFETs, avalanche junctions, spintronic devices, thick film or composite carbon resistors, and corona discharge.

This analog signal is anti-aliased, digitized, and frequency compensated (for example by a sinc function) by ADC 101. Depending on the embodiment (such as the amount of available processing power), the data might not be able to be processed in real time. In that case, it is stored in database storage 102 such as local disk or the cloud. Such storage is also desirable for logging the incoming data for scientific purposes. I/O for conversions may be files, for use in a networked database. Data can also be streamed in through a network connection 103. The desired signal source is selected by multiplexer or switch 104 to supply a data stream 105.

Sub-assembly (or sub-process) 106 processes input stream 105 and generates output stream 109. The compute-intensive part of the system is comprised mainly by blocks 107 and 108. This subsystem may be implemented in low level software or as hardware (Verilog/VHDL). We propose calling the hardware version of 106 an EPU (Euler Processing Unit). An EPU would benefit any modern computing device running consciousness applications. Process 106 may also be implemented in software, as with many patented causal-time-only CODECs such as AAC, MP3, etc.

A multiplicity of ω values may be applied to the same incoming data by feeding process 106 the same input stream for each ω. The resulting output streams 109 may be fed to a computer 113 for storage and presentation on display 112, such as in a spectrum analysis application. A single output stream may be listened to by sending it out DAC 110 (with sinc pre-emphasis and filtering, normally built into audio CODEC hardware) to speaker 111 or headphones. Computer 113 may apply pattern matching algorithms to identify signal patterns and then save the streams containing signal to storage or apply further processing to supply useful data to applications.

FIG. 1B shows the data flow of demodulation process. This process 120 starts with input stream 105 which can be a file, data structure, or an anti-aliased and digitized analog signal. The data from 121 is stored to an input buffer 122 of sufficient size to handle the warp indexing. Usually, this would be a circular buffer in RAM. For each incoming data point, data set X will be read from buffer 121 multiple times to process overlapping data sets. The size of the RAM is a little larger than X to accommodate the relatively small of incoming data per processing cycle.

Input Warping:

Downsampling process 124 translates the sample pitch of X (memory 122) to the sample pitch of Y (memory 125) using an exponential sweep. In the industry, this is known as exponential time-warping.

An exponential chirp sweeps from f₀ to f₁ in a time T. M points of X get mapped onto N points of Y, where M>N. Let R be a scaled version of ω for use in the exponential warp and α is the X input sample rate in samples per second. Given a particular R and N, M and ω may be calculated.

$$\begin{matrix} f = {f}_{0} \cdot {e}^{ɛ t} , where ɛ = {( {f}_{1} / {f}_{0} )}^{1 / T} . & [ Math . 2 ] \\ Let y = {e}^{R / N} . N = {\sum }_{n = 0}^{M} {y}^{n} = y ( {y}^{M} - 1 ) / ( y - 1 ) + 1. & [ Math . 3 ] \\ Let χ = \vert R \vert / N . M = - ln ( {e}^{χ} \cdot ( N - 1 ) \cdot ( {e}^{- χ} - 1 ) + 1 ) / χ . & [ Math . 4 ] \\ ω = α R / N , in units of “ e ’ s per second ” e / s . & [ Math . 5 ]\end{matrix}$$

M is the required size of X memory 122. It isn't necessarily needed for calculations. It may be used to set the iteration count of the downsampler, depending on the implementation. Parameters for warping can be computed without the need for transcendental functions since they lend themselves to easy approximations.

|M| may be between 0 and 1. The value of M/N “blows up” as |R| approaches 1. High values of M/N are undesirable, as much of the X range gets squeezed into a small amount of the Y range. The point of diminishing returns for M/N is between 2 and 4. For example, at R=0.797, M/N is 2 and the sample pitch ranges from 1 to 4.93. An upper limit of 2 for M/N is reasonable from both a mathematical and a hardware standpoint. For example, if max M is 2N, N=1024, and α=10000 samples/second, then |ω| ranges between 0 and 7.78 e/s.

Resampling is done on N points (of Y) at a time where the respective indices of X and Y are δ and i. The time span is from 0 to i/N where i sweeps from 0 to N−1 and N is the number of samples. Let λ be the sample pitch of X. It will increase or decrease exponentially and should have a minimum value of 1.0, but may have a minimum value of less than one to allow for rounding error.

This causes a chirp of matching R to be re-sampled to the upper frequency (either f₀ or f₁ depending on the sign of R). Given output index i, input sample index δ(i) is the accumulated sum of λ(i). The exponential sweep can be implemented with a multiplier. For each step:

λ=λ+(λ·Λ), where λ is initialized to 1.0 or e^{RM/N}. [Math. 6]

The initial value of λ when R<0 is 1.0. Otherwise, with χ=R/N, it's:

λ=1/(e^{χ}·(N−1)·(e^{-χ}−1)+1), which with small χ approximates to: [Math. 7]

λ≈1/(1+χ−R), as a first order approximation (0.1% to 1% error), or: [Math. 8]

λ≈1/(1+(χ+χ²/2)(1−N)), which is always sufficiently accurate. [Math. 9]

The exponential sweep needs a small correction factor:

e^{R}=(1+Λ)^{N}, which becomes Λ=e^{R/N}−1. When R/N is small, [Math. 10]

Λ≈R/N−(R/N)²/2, due to Taylor series of e^{x}. [Math. 11]

δ=δ+λ, index of X array stepped by the sample pitch. [Math. 12]

The i index is stepped from 0 to N−1, where N is a power of 2 (although it doesn't have to be) for the convenience of the FFT. The δ index sweeps non-linearly from 0 to M. For each X, the index δ (the output of process 124) is the running sum of λ. For each Y point, process 123 sums one or more X points using linear interpolation.

Process 123 sums λ input samples to form each Y[i] sample. This takes care of the Mellin transform's exponential scaling step. The total value of the span of points from X[δ] to X[δ+λ] is stored to Y[i] (memory 125). For the endpoints, only part of each point is included. For example, if λ is 2426.33, a third of X[2426] is used. With a maximum λ of 4.93, (max M/N set at 2), the data width of the output of downsampler process 123 is three bits wider than the input. The actual allowed M/N should be limited by the width of the output. For example, with a 3-bit growth, λ can be up to 8, which allows M/N=2.36 and 3 octaves/span. With 2-bit growth, λ can be up to 4, which allows M/N=1.85 and 2 octaves/span. The latter case is preferable due to compression losses. A 16-bit input stream would produce an 18-bit stream into Y. The maximum ω is then about 1.56α/N.

The downsampler should be preceeded by a digital filter whose cutoff frequency is below Fs/2λ. Without the filter, apparent frequencies above Fs/2 will alias into the data stream. A couple of 2^{nd} order Biquad LPF stages in series does a good job, and requires calculation of three parameters to set the cutoff frequency. The parameters may be computed once (given R and N) and kept in a table of filter coefficients in RAM. This table is indexed by λ. Linear interpolation can be used to reduce the table size.

The Y samples may be scaled by the square root of λ so that they are proportional to √λ rather than λ. This would level the noise due to noise going down as the square root of the X sample pitch. It also would remove the low frequency emphasis that would otherwise be there.

An alternate method of interpolation would interpolate between Y[i] and Y[i+1] outputs of the digital filter to allow rational λ. This allows simplification of process 123. Instead of accumulating λ samples of X, it can interpolate from two samples of Y and then scale by √λ as mentioned above to balance the spectrum.

FFT:

After X is time warped into Y, Y (data set 125) is processed by a FFT (Fast Fourier Transform) 126 and converted to data set U (memory 127) containing N/2 frequency bins. Data sets 125 and 127 may share the same physical memory. The FFT should be performed in place to avoid extra memory requirements, although a pipelined version would deliver higher throughput.

Polar format is preferred for the output of the FFT, for the benefit of the upsampler. Note that the same pipelined CORDIC, if used, can handle the FFT, supply the polar format, and be shared with the correlator to perform polar to rectangular conversions.

If the FFT is an integer implementation, it should have room for bit growth (if any) and a few extra bits for accumulation of quantization errors. For example, each rank of radix-2 butterfly contributes 0.5 LSB of noise. In 10 ranks, that's 5 LSBs of noise, so the word size should be increased by 2 bits to accommodate it. These LSBs would be then dropped off the result.

Y (data set 125) has a window function (such as Hann or Blackman) applied to it before the FFT is performed. The FFT may be the decimation-in-time type. The input to a DIT-FFT is bit-reversed. The downsampler should store data set 125 in bit-reversed format, so all the FFT has to do is scale it by a bit-reversed Hann window. The technique of bit-reversal-in-place takes longer.

The type of FFT depends on the implementation. For example, a pipelined CORDIC would perform the rotations within FFT ranks as well as the applying the input Hann window and final rectangular-to-polar conversions. On generic computing hardware, the Cooley-Tukey and Bluestein methods are very efficient. SIMD extensions to modern microprocessors, designed to support the CODECs used in modern audio and visual media, are friendly to FFT computations.

In an ASIC implementation with a single working memory, processing time is dominated by the FFT. Single-ported RAM is preferred because dual-ported RAM, while it would allow concurrent processing of warping and FFT, would cost twice the die area. Die area would be better spent on more instances of the overall demodulator process.

Output Warping:

U memory 127 is upsampled by process 129 to form time-domain signal V (130). Let and j be the respective indices of U and V. For every index ε of U, the corresponding frequency can be normalized to Fs/2.

f=ε·(Fs/2)/(N/2)=(Fs/2)·e^{ω(t-τ)} [Math. 13]

where τ is the absolute time at X[0]. It's easier to work in terms of exponents, so the preferred re-mapping (another exponential time-warping) extracts U[ε] from a linear progression of V[j]. Warp indexing process 128 uses the relation:

ε=(N/2)e^{ω(t-τ)} [Math. 14]

Time t (scaled to match the output stream's sample rate) sweeps from τ in the opposite direction of R's sign, causing the exponent to start at 1 and decay downward.

Up-sampling U[ε] to V[j] can't use the traditional interpolation scheme (zero stuffing) because the interpolation factor must be irrational. Instead, partial contributions to V[j] are extracted from one or two U points by interpolation.

Let Δ be the time between conversion frames, α the input sample rate, β the output sample rate, γ the input oversampling factor, and P the number of output points in period Δ.

P=βΔ. [Math. 15]

ε(j)=(N/2−1)e^{Rj/P} [Math. 16]

The pitch of ε should be 1 (when j=0) for the lowest signal loss, but it can be lowered to reduce the computational load.

(N/2−2)=(N/2−1)e^{R/P}, so: [Math. 17]

P=R/ln(1−2/N), which for large N is: [Math. 18]

P≈0.35NR [Math. 19]

The sample rate relations are then:

α≈3βγ/R [Math. 20]

β≈αR/βγ [Math. 21]

Low values of ε are not practical to include, as they stretch out the time scale to a point of not being useful. Choosing a tentative lower limit of:

ε=N/10=(N/2−1)e^{Rj/M} gives a max j: [Math. 22]

j₁=P·ln(0.2)/R≈−1.6P/R [Math. 23]

j ranges from about 0 to j₁. Each re-sampling result V[j] (130) is the contribution of the corresponding span U[εⱼ] to U[εⱼ₊₁], which has a pitch of less than 1. As the pitch gets finer, each V[j] gets less power from the associated U[ε]. The exponential decay can be handled by repeated multiplication.

The exponential sweep needs a small correction factor:

e^{R}=(1+ζ)^{P}, which becomes ζ=e^{R/P}−1. When R/P is small, [Math. 24]

ζ≈R/P+(R/P)²/2, due to Taylor series of e^{x}. For each iteration, [Math. 25]

ε=ε·(1+ζ) initialized to (N/2−1) or near top of FFT spectrum [Math. 26]

Since ε is always positive, the upchirp case of R>0 needs to have its j index mirrored by using V[M−j−1].

The alternative approach is to step through U one element at a time (from N/2−1 downward) and each element onto the corresponding (1 or more) elements of V. This involves computing a logarithm as well as reading and writing V multiple times, so it's generally less efficient than interpolating from U.

V is added to output buffer 132 by correlator 131, staggered in time (by P samples) for each processing block. When the downsampler's R value matches the chirp rate of a simple incoming chirp, multiple peaks in the warped FFT output correlate in the output stream to produce a corresponding output pulse in the W stream. A more complex signal such as overlapping and/or modulated chirps will produce pulse trains and/or modulation envelopes in the W stream.

Elements of V (data set 130) may be real (magnitudes only) or complex. Complex is used when high selectivity is required: Multiple rotating vectors will sum to zero, while vectors pointing in the same direction (chirps matching R) will correlate. Correlation through vector averaging allows the use of a much smaller FFT than scalar-only averaging. The rate of phase rotation is proportional to the FFT result frequency, so selectivity is higher at the upper end. Since the low end of the FFT result isn't used, lower selectivity there isn't a problem.

Due to the requirement that phase rotation be stationary across many FFT results for signal detection, the exponential sweeps used in downsampling and upsampling should use high precision math for correct tracking.

Correlator 131 should be able to work with either vectors or real magnitudes (no phase data). This would be used in signal search, where low selectivity is desired.

The data in output buffer 132, where the accumulations occur, is in rectangular format, while the data coming from upsampler 129 is in polar format. The correlation process may use a CORDIC to perform polar-to-rectangular conversion.

W is output to data stream 109, a file, data structure, or DAC with reconstruction filter and sinc correction.

### Example 2

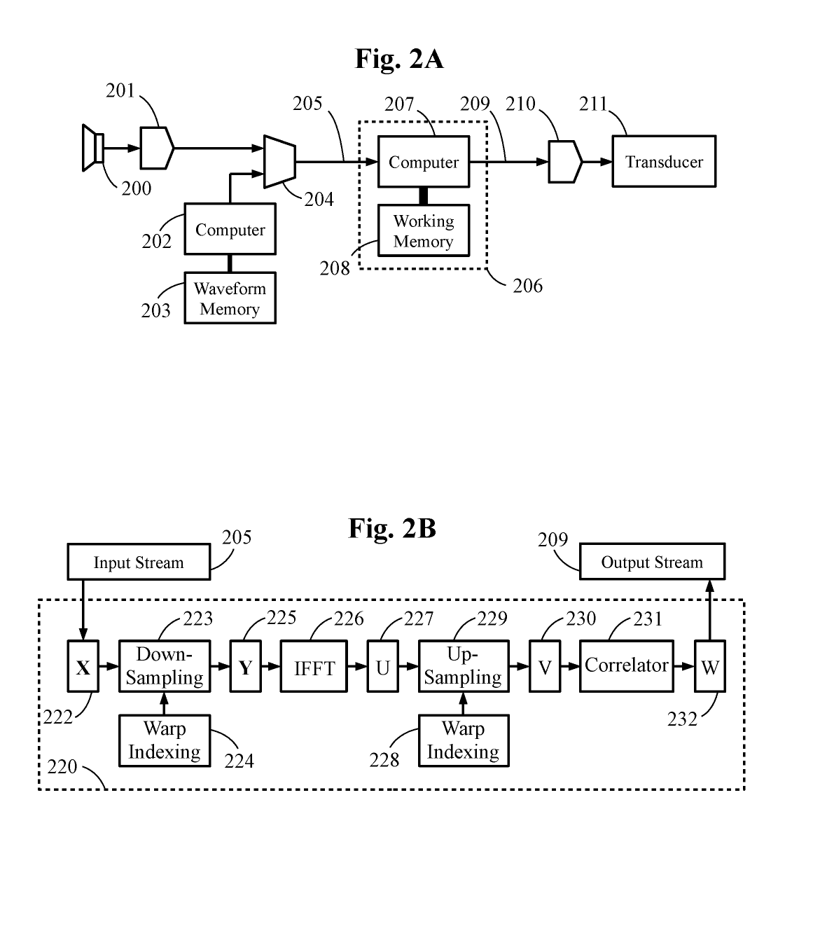

FIG. 2A shows an embodiment of an apparatus for causal to emergent time conversion, the reverse of FIGS. 1A and 1B. The input stream consists of complex data. Microphone input 200 is anti-aliased and digitized by ADC 201. Since phase data is unknown, the imaginary component of the audio is set to zero. For waveform synthesis applications, a computer 202 supplies a complex “arbitrary” waveform from data stored in memory 203. Multiplexer/switch 204 selects the source for input signal 205.

Reverse conversion uses essentially the same hardware as the forward conversion in Example 1. Computer 207 and working memory 208 form processing core 206 that performs the conversion. Output stream 209 is output to a CODEC or a DAC 210 with reconstruction filter and sinc correction. The resulting wideband analog signal is used to modulate transducer 211. The transducer may be a wideband RF transmitter, LED, laser or microwave oscillator. Or, it could be a plasma discharge such as dielectric barrier discharge, RF-excited plasma, or hot plasma.

FIG. 2B shows causal time domain to emergent time domain conversion process 220. A causal-domain data stream 205 is fed into input buffer 222. The ε(j) calculation of process 128 is replicated in process 224, with downsampler 223 working in reverse (undersampling complex vectors X into Y) to form a spectrum in memory 225. An inverse FFT 226 converts it to a time domain spectrum 227. Warp indexer 228 is likewise the same as 124 (but working with scalars rather than vectors), with upsampler 229 warping in reverse to produce the corresponding chirp pattern in buffer 230. Buffer 230 is optional, as it may be rolled into correlator 231. Correlator 231 builds the waveform in buffer 232, some of which gets sent to output stream 209 in each pass.

### Example 3

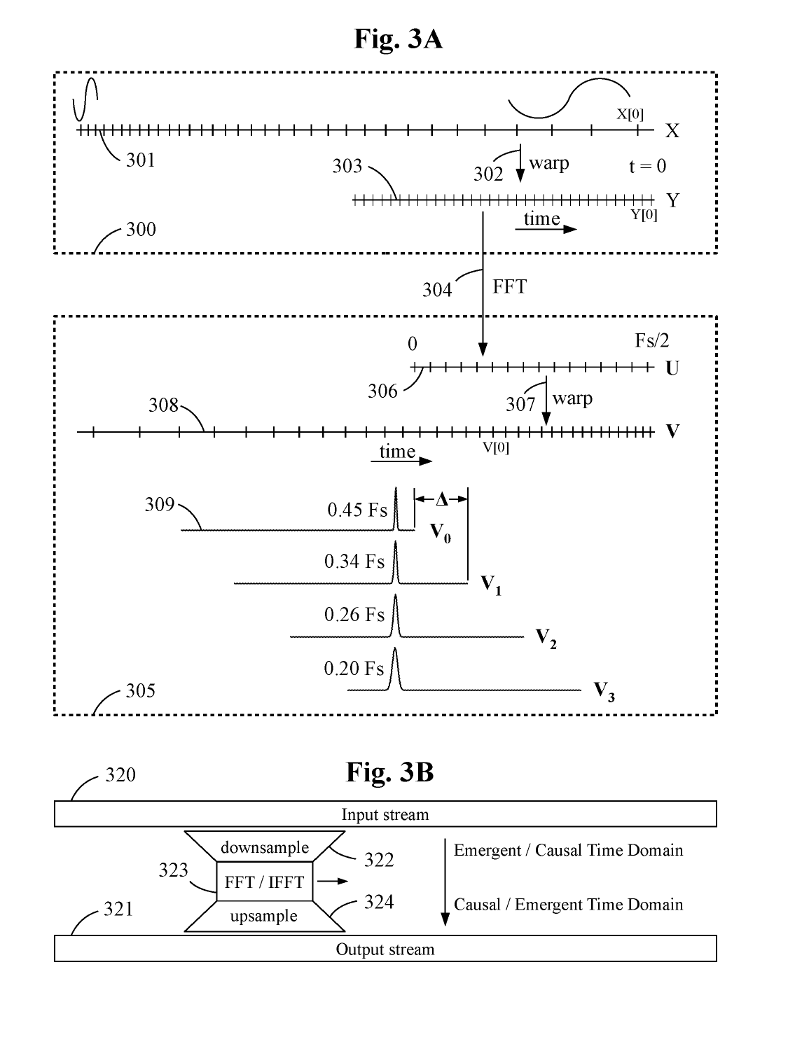

FIG. 3A shows a graphical conceptual view of the demodulator's data flow. Input time domain 300 contains a downward (decreasing frequency) exponential chirp 301. The warping function 302 re-samples it to uniform time spacing. The resulting signal 303 is processed by an FFT.

Time domain 305 occurs a fixed amount of time after 300 congruent with data processing delays. FFT output 306 is re-sampled by an exponential warping function 307 to match signals with chirp rate R in time, producing warped spectrum 308.

The lower 15 to 30 percent of FFT output 306 is discarded due to this portion being spread so thin (covering a wide time range) that it may be discarded (saving significant processing power) without adverse effect.

In this example, the chirp shows up in the FFT result four times. Each instance of time-warped spectrum 309 matches up in time, given a constant time offset A. These are summed to produce the output stream. The frequency of each peak in 309 illustrates the exponential relationship between them, which is linearized by 307. Single chirp 301 in the input stream produces a single impulse (a summation of 309) in the output stream.

FIG. 3B illustrates the conversion process moving forward in time along the I/O streams. There are two use cases: demodulation and modulation. In demodulation, input stream 320 is in the emergent time domain and output stream 321 is in the causal time domain. Downsampler 322 decimates the input by 1:m, where decimation factor m is exponentially swept upward from or downward to 1.0. The “warp factor” is the growth rate in m. The input stream consists of real numbers. FFT 323 performs a real-to-complex FFT to produce a warped spectrum which is treated as time domain envelope of magnitude and phase information. To un-warp the spectrum, upsampler 324 interpolates it by 1:m where decimation factor m is exponentially swept upward to or downward from 1.0. Output stream 321 consists of vectors that are many accumulations of upsampler results.

For modulation, input stream 320 is in the causal time domain and output stream 321 is in the emergent time domain. Downsampler 322 decimates the input by 1:m, where decimation factor m is exponentially swept upward from or downward to 1.0 and the resulting spectrum ranges from about N/8 or N/4 to N/2. The “warp factor” is the growth rate in m. The input stream consists of complex numbers. FFT 323 performs a complex-to-real FFT to produce a warped time domain envelope. To un-warp the it, upsampler 324 interpolates it by 1:m where decimation factor m is exponentially swept upward to or downward from 1.0. Output stream 321 consists of many accumulations of upsampler results.

The same hardware can be used as a modulator or demodulator if the FFT/IFFT modules use the same basic hardware. FFTs can use optional complex conjugates in their butterflies, for example, to perform IFFT. In the case where the FFT is replaced by FHT (all points are real numbers), the FHT is its own inverse.

### Example 4

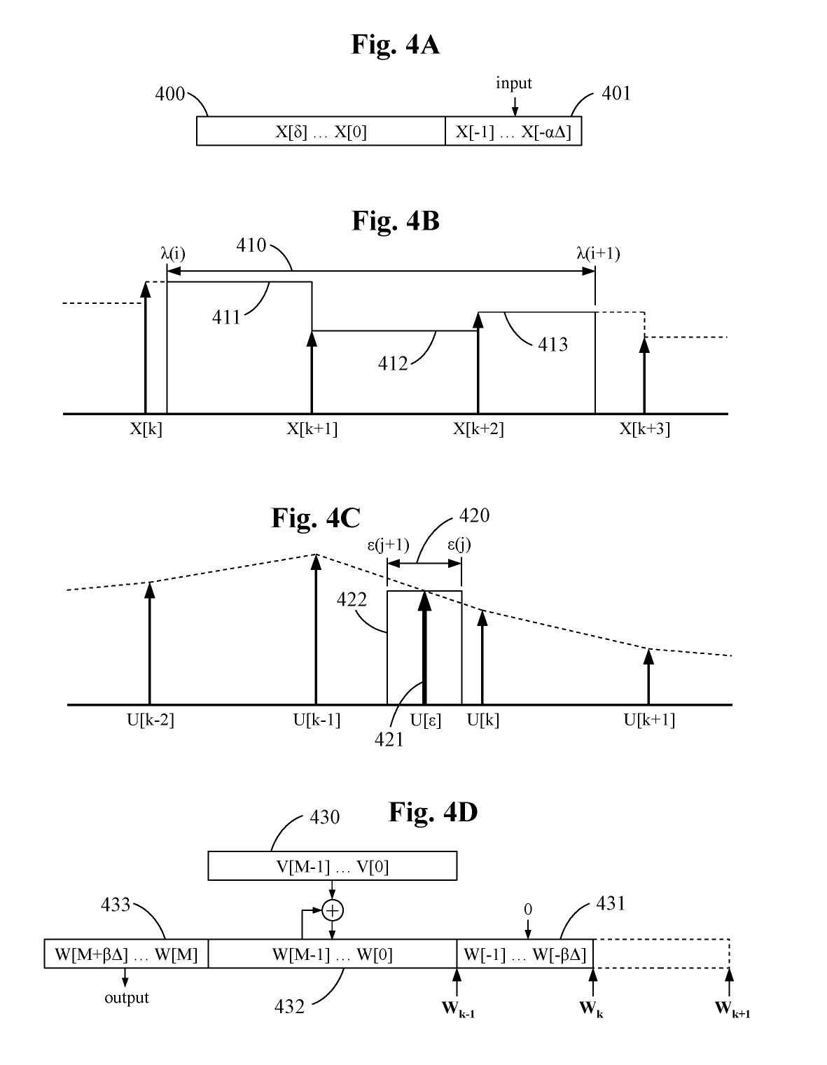

To elaborate on the warping functions and memory layout, FIG. 4A through FIG. 4D illustrate a programmer's point of view. FIG. 4A shows input buffer 122.

FIG. 4B shows downsampling of X to Y, which are both in polar format. One or more points (span 410) are added together to form output point Y[i], which is basically the area under the curve. Y[i] is the sum of the areas at the endpoints 411 and 413, and middle section 412 consisting of the sum of zero or more X points. An alternative embodiment could use RMS summing rather than linear summing to improve S/N performance. In RMS summing, the points are squared before summing, and the square root taken of that sum. Note that the X data should be low-pass filtered if aliasing is to be avoided.

One example of this X summation (in hardware) has the X stream put through a two-stage pipeline: X→X1→X0, where X is a memory data bus and X1 and X0 are pipeline registers. The integer and fractional parts of δₙ are δ_{n.I} and δ_{n.F} respectively. Let δ₀ and δ₁ be the endpoint indices and k=(δ_{1.I}−δ_{0.I}). Operations are typically performed in one cycle.

When (k=0),Y[i]=X0·(1−δ_{0.F})−X0·(1−δ_{1.F}), performed in one cycle. [Math. 27]

When (k=1),Y[i]=X0·(1−δ_{0.F})+X1·δ_{1F}, performed in one cycle. [Math. 28]

When k>1,Sum=X0·(1−δ_{0.F})+X1. Cycles continue: [Math. 29]

When k>1, points in region 412 (each X1) accumulate in Y[i] each cycle. In the last cycle, when X[δ_{1.I}] is in X1, region 413 is also added:

Y[i]=Sum+X1·(1−δ_{1.F}) [Math. 30]

FIG. 4C shows upsampling of U to V. It uses linear interpolation to construct a curve to extract from. In this case, the width 420 is less than 1.0 samples. The height 421 of U[ε] is interpolated and multiplied by width 420 to get the area under the curve, 422, to be stored in V[j]. As the warp proceeds backward in frequency (from Fs/2), 420 shrinks so that at some point large j values aren't worth computing. The tradeoff between maximum j and compute time should be adjustable.

One example of this interpolation in hardware has the U stream put through a three-stage pipeline: U→U2→U1→U0, where U is a memory data bus and U2, U1 and U0 are pipeline registers. Let ε₀ and ε₁ be endpoint indices and χ=ε₁−ε₀. U may be scalars or (Q, I) vectors.

When ε_{0.I}=ε_{1.I},V[j]=χ·(U0·(1−(ε_{0.F}+ε_{1.F})/2)+U1·(ε_{0.F}+ε1.F)/2); else: [Math. 31]

V[j]=χ·(U0·ε_{0.F}+U1·(1+ε_{1.F}−ε_{0.F})+U2·(1−ε_{1.F})) [Math. 32]

FIG. 4D shows the output correlator, another view of output buffer 131. The output stream flows from right to left, being initialized to 0 in region 431. After each vector 430 is added to vector 410, the physical index moves βΔ points to the right. Region 433 is out of the range of summation activity, so it may be output to a file or ADC. Simple averaging is shown here, but RMS summing could be used for more accuracy: Regions 430 and 432 would be squares, and square roots would be taken at the output 433.

### Example 5

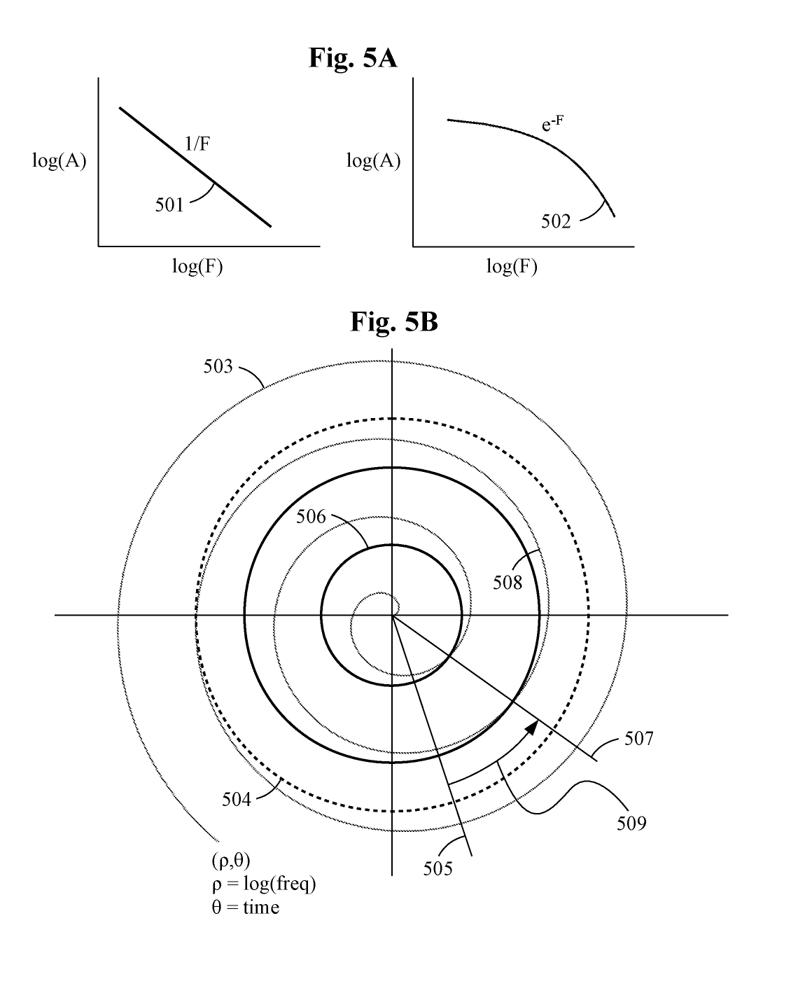

FIGS. 5A and 5B illustrate a the relationship between emergent time and causal time in a graphical way. In FIG. 5A, Superposition of discrete exponential chirp spectra 502 forms flicker noise spectrum 501 (both are log-log plots).

A convenient way to relate the emergent and causal time domains is by means of a logarithmic spiral. The relationship between emergent time and causal time can be thought of as a 2D plot in log-polar format. Log-polar format renders a logarithmic spiral as a linear (Archimedean) spiral. The spiral's radius is [Math. 33] ρ=kθ, where k is a rate constant. ρ can represent either time or frequency by flipping the sign of k. For purposes of signal processing, let ρ represent log frequency and θ causal time.

FIG. 5B plots an exponential chirp in log-polar format. The system processes a sample chirp 103 as follows.

A line 505 or 507 can be drawn outward from the center of the spiral 503, crossing it at multiple points. The line rotates counterclockwise at step size 509 corresponding to the oversampling rate. For example, if the oversampling rate is 36 (each input value is used 36 times), the step size is 10°. Each angular sweep of the unit circle (beginning and ending at line 505 or 507) represents the input to a version of the Mellin transform called the “Exponential Chirp Transform” (ECT) described by Bonmassar. The ECT is basically a FFT with time-warped input. The transform's frequency domain output is along the line 505 or 507 from approximately ρ=0 to Fs/2, where Fs/2 (the Nyquist frequency) is shown by circle 504. The radius of circle 504 represents the approximate bandwidth of the system.

The ECT time-warps chirp signal 503, which represents a single “emergent tone” in FIG. 1. In the 360° sweep at line 505, signal 503 is time-warped to a tone 506 in causal time. A time 509 later, at line 507, signal 503 is time-warped to a tone of different frequency 508. All time warping is exponential. Note that “exponential time warping” is different from dynamic time warping, a popular means of pattern-matching mostly linear signals.

The correlation effect can be visualized as a spinning spiral illuminated by a strobe light. When the strobe frequency matches the rate constant of the spiral(s), it appears to be standing still. Otherwise, it's a blur.

While preferred embodiments of the invention have been described, the present invention is not limited to these preferred embodiments, but includes everything encompassed within the scope of the appended claims and all alterations and modifications as would be apparent to those in the art based on this disclosure.

### INDUSTRIAL APPLICABILITY

EEG data can be analyzed by an MCU or DSP to detect mental state, stress, deception, and states of consciousness. More accurate consciousness assessment would avoid costly anesthesia errors.

ECG and heart rate data can likewise be used to analyze stress and mental state. It may also be used to diagnose heart health, as studies have found much 1/f noise in healthy patients.

Since human cortical structures have evolved to process information in log-polar format, visual conceptual information should be detectable using the appropriate sensor. This would allow for measurement of quality-of-life metrics, which would facilitate good mental hygiene.

Once understood, consciousness signals could be synthesized and transmitted into the body for targeted healing. Health problems that are detected by “signature” can have that signature electronically corrected for therapeutic use.

### CITATION LIST

### Patent Literature

| | | | |
|---|---|---|---|
| 4581715 | April 1996 | Hyatt | (FFT) |
| 4553213 | November 1985 | Hyatt | (Correlation filter) |

### Non Patent Literature

Brunet, O. (2016). “Geometric Time and Causal Time in Relativistic Lagrangian Mechanics”. arXiv:1609.02040 [gr-qc]
Moreva, E. et al (2014). “Time from quantum entanglement: an experimental illustration”. Phys. Rev. A 89, 052122
Milotti, E. (2002). “1/f noise: a pedagogical review”. arXiv:physics/0204033 [physics.class-ph]
Bonmassar, G., Schwartz, E. L. (1997). “Space-variant Fourier analysis: the exponential chirp transform”. DOI: 10.1109/34.625108
Schwartz, E. L. (1981). “Cortical anatomy, size invariance, and spatial frequency analysis”. Perception, 10:455-468.

1. An apparatus for converting signals from an emergent time domain to a causal time domain, comprising a computer having a memory store; wherein the computer is disposed to receive a data stream containing classical noise, exponentially time warp the incoming stream, convert it to the frequency domain by FFT, exponentially time warp the frequency domain, and correlate the overlapping results to produce an output stream for the purpose of demodulating signals produced in emergent time.

2. An apparatus for converting signals from a causal time domain to an emergent time domain, comprising a computer having a memory store; wherein the computer is disposed to receive a data stream containing a signal to be modulated, exponentially time warp the incoming stream, convert it to the time domain by IFFT, exponentially time warp the time domain, and correlate the overlapping results to produce an output stream for the purpose of mimicking 1/f signals produced in emergent time.

3. The apparatus of claim 1, where the input stream is a real-time or stored digital waveform and the output stream is converted to an analog output, stored, or processed by a computer application.

4. The apparatus of claim 2, where the input stream is a real-time or stored digital waveform and the output stream is converted to an analog output to modulate an energy source.

5. The apparatus of claim 3, where the input stream is supplied by a semiconductor device “noise source” such as MOSFET, PN junction, avalanche junction, reverse biased Schottky diode, carbon resistor, corona discharge, or chaotic oscillator.

6. The apparatus of claim 3, where the input stream is supplied by a wideband RF or optical detector, spintronic device, or plasma noise source such as dielectric barrier discharge or RF-excited plasma.

7. The apparatus of claim 3, where the input stream is supplied by a biophysical process sensor such as EEG, ECG, pulse oximeter, heart rate sensor, or respiration monitor.

8. The apparatus of claim 5 having a spectral display.

9. The apparatus of claim 4, where the output stream modulates an emitter such as dielectric barrier discharge, RF-excited plasma, microwave oscillator, wideband RF, LED or laser.
